(19) United States
(12) Patent Application Publication
(10) Pub. No.: US 2004/0256395 A1
(43) Pub. Date: Dec. 23, 2004

(54) Reinforced high strength foam insulation

(75) Inventors: Tibor I. Lak, Huntington Beach, CA (US); Andrew T. Lak, Huntington Beach, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: The Boeing Company

(21) Appl. No.: 10/463,092

(22) Filed: Jun. 17, 2003

(51) Int. Cl. F17C 1/00

(52) U.S. Cl. 220/560.15

(57) ABSTRACT

A reinforced sprayed-on foam insulation (SOFI) and method of installing the reinforced sprayed-on foam insulation in which a reinforcing web is embedded within the foam or overlays the outer surface of foam applied to a cryogenic storage vessel. After application to the cryogenic storage vessel, the invented insulation prevents foam fragments from separating from the cryogenic storage vessel when placed under thermal or physical stress.

### FIELD OF THE INVENTION

The present invention relates to reinforced foam insulation. More particularly, the invention relates to reinforced foam insulation for use on cryogenic storage and distribution systems such as those used with reusable launch vehicles.

### BACKGROUND OF THE INVENTION

Liquid fuel rocket engines are commonly used to propel reusable launch vehicles, such as the Space Shuttle, and expendable launch vehicles such as the Delta IV, and Atlas V. These rocket engines often use low temperature cryogenic fuels, such as liquid oxygen and liquid hydrogen. Because of the very low operating temperature of these fuels in the liquid state, insulated fuel tanks and feed lines are needed. The insulation prevents environmental heat from warming the cryogenic liquid and also prevents ice formation on the insulation surface.

The application of sprayed-on foam insulation (SOFI) has proven to be an effective means of insulating cryogenic storage tank and distribution systems. The SOFI adheres directly to the surface of a cryogenic storage vessel and provides a foamed layer with favorable insulating properties.

The SOFI currently used on ground storage tanks and launch vehicles can crack and separate due to stresses induced during thermal contraction of the tank skin or due to external physical forces applied to the tanks or insulation. Once cracked, air may be introduced into the voids formed by the cracks. Air introduced into the insulation voids may freeze internal to the foam and also on the surface of the tank at the tank-foam interface. This frozen air consequently can rapidly melt and vaporize during liquid feed-out due to internal tank heating form the hot tank pressurization gas, and from external launch ascent heating. The internal pressure build-up due to solid air melting, and vaporization can result in large internal forces that can dislodge portions of the foam insulation from the tank and feed system.

It is desired to provide a high strength reinforced sprayed-on foam insulation that resists separation and foam loss from an insulated fuel tank and feed system lines and components. It is further desired to provide a reinforced sprayed-on foam insulation that, in the event of insulation cracking and separation, minimizes the size of the insulation that can separate from the insulated tank.

### SUMMARY OF THE INVENTION

A reinforced sprayed-on foam insulation (SOFI) and method of installing the reinforced sprayed-on foam insulation are provided in which foam insulation is adhered to the outer surface of a cryogenic storage vessel or feed line (collectively “cryogenic vessel”) and a reinforcing web is disposed about the outer surface of the cryogenic vessel such that the foam material is disposed around the reinforcing web or between the web and the outer tank surface. The invented high strength foam insulation resists separation from the cryogenic storage vessel when placed under thermal or physical stress. Taken together, the vessel and insulation form a high-integrity cryogenic storage system that eliminates foam loss and thereby significantly improves safety and reduces maintenance costs associated with cryogenic storage systems.

According to a first embodiment, a reinforcing web is provided within the foam matrix of the insulation. In order to embed the web within the foam matrix, a web layer may be suspended above the surface of a vessel to be insulated. As SOFI is applied to the surface of the vessel, the polymeric foam expands and rises from the vessel surface, eventually engulfing the web layer and incorporating the web into the foam. Alternatively, a web layer may be rested upon the outer surface of the cryogenic vessel prior to application of the foam. As the SOFI is applied to the surface of the vessel, the rising of the foam causes the web to be lifted from the surface of the vessel and suspended within the foam matrix as the foam cures.

According to a second embodiment, the web may be applied to the outer surface of the foam after the foam has cured and hardened. When the web is applied to the foam after the foam has hardened, it is advantageous to apply the web around the circumference of the vessel body such that the reinforcing web provides a protective ring around the reinforced region of the foam.

The web layer is a lightweight screen-type material. The web material may be made from a variety of materials, including metal and plastic materials. The web advantageously comprises a wire-type material arranged in a regularly repeating geometric configuration. One or multiple web layers may be used in accordance with the invention.

According to another embodiment, the insulation is installed upon a vessel by first mounting a series of spacer brackets to the outer surface of the vessel. The spacer brackets serve to space one or more layers of web material from the surface of the vessel. The spacer brackets may be made of metallic, composite, polymeric, or other material, and can be of any shape, for example a rectangular shape, pin shape, “L” shape, etc.

After installation of the spacer brackets, the reinforcing web layer is attached to the brackets such that the web layer is spaced apart from the outer surface of the vessel and such that the web layer follows the general contours of the underlying vessel surface.

After installation of spacer brackets and the web layer, spray-on foam insulation (SOFI) is applied to the surface of the vessel. The foam is adhesively bound directly to the surface of the vessel and applied to such a thickness that the resultant foam envelopes the spacing brackets. Depending on the resultant thickness of the foam, the foam either envelopes the web layer or contacts the web layer at the outer surface of the foam.

According to any of the above embodiments, if the adhesive bond between the foam and vessel fails and the foam material fragments, the web layer acts as a physical reinforcement element that retains all foam fragments of substantial size. The invented insulation therefore advantageously remains attached to the insulated vessel even if the foam component of the insulation is fractured.

Since the invented high strength foam insulation prevents foam loss, the operating cost of insulated cryogenic storage and distribution systems are greatly reduced with use of the invention. The invention is particularly useful when installed on mobile and flight based cryogenic systems, and results in longer foam life and a reduced need for inspection.

### BRIEF DESCRIPTION OF THE DRAWINGS

Having thus described the invention in general terms, reference will now be made to the accompanying drawings, which are not necessarily drawn to scale, and wherein:

FIG. 1 shows reinforced insulation in accordance with an embodiment of the invention having no spacer brackets;

FIG. 2 shows reinforced insulation in accordance with an embodiment of the invention having spacer brackets;

FIG. 3 shows a side cutaway view of reinforced insulation in accordance with another alternative embodiment of the invention without spacer brackets;

FIG. 4 shows a side cutaway view of reinforced insulation in accordance with a further alternative embodiment of the invention without spacer brackets;

FIG. 5 shows a side cutaway view of yet another alternative embodiment of the invention without spacer brackets;

FIG. 6 shows a side cutaway view of reinforced insulation in accordance with another alternative embodiment of the invention with spacer brackets;

FIG. 7 shows a side cutaway view of reinforced insulation in accordance with a further alternative embodiment of the invention with spacer brackets;

FIG. 8 shows a side cutaway view of yet another alternative embodiment of the invention with spacer brackets;

FIG. 9 shows a foam covered vessel surrounded with a web layer in accordance with an embodiment of the invention;

FIG. 10 shows a cryogenic vessel, namely an External Tank as used with a Space Shuttle Orbiter;

FIG. 11 and 11a show an embodiment of an External Tank with an inset showing installed spacer brackets in accordance with the invention;

FIG. 12 and 12a show an embodiment of an External Tank with an inset showing an installed web in accordance with the invention; and

FIG. 13 and 13a show an embodiment of an External Tank with an inset showing installed SOFI foam insulation in accordance with the invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

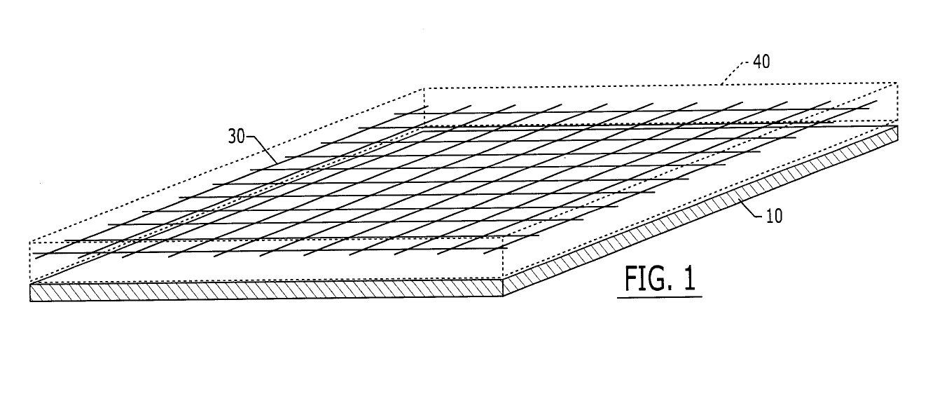

Referring now to FIG. 1, one embodiment of the reinforced insulation is shown installed upon the surface of a vessel 10. Spray-on foam insulation 40 is adhered to the surface of the vessel 10. A web 30 is suspended within the foam or layered against the outer surface of the foam such that the web 30 is physically spaced away from the surface of the vessel 10.

The vessel 10 is a tank, a feed line, or a other container capable of directly or indirectly containing cryogenic liquids. The vessel 10 may contain cryogenic liquids held directly in contact with the walls of the vessel 10 or the walls of the vessel 10 may be separated from the cryogenic fluids by one or more layers of insulating material. Alternatively, the vessel 10 may comprise a housing that surrounds one or more smaller cryogenic containers. The vessel walls are typically metallic, but may be constructed of polymeric materials or other structural materials capable of withstanding the temperature fluctuations due to the loading and unloading of cryogenic fluids. While an example of the vessel is provided below in which the vessel is a fuel tank of a spacecraft, such as the Space Shuttle, the reinforced insulation of the present invention is useful with vessels utilized in other applications as well.

The spray-on foam insulation (SOFI) may be closed cell or open cell foam, as typically applied to cryogenic storage and feed distribution systems, that adheres directly to the surface of the vessel 10. Suitable foams include but are not limited to closed-cell polyurethane, polystyrene, rubber, and silicones. An example of such a spray-on foam is Corbond® II, a spray-on polyurethane foam having a density of 1.8 lb/ft³, closed cell content of 93%, and tensile strength of 35 psi, available from Corbond Corporation, Bozeman, Mont. The foam is applied in one or several passes to the desired thickness.

The web 30 is typically constructed of a wire shaped material having high tensile strength and high heat tolerance, such as metal wire, carbon fiber, polypropylene, or heat resistant polymeric fiber such as Nomex™ fiber. The web 30 is preferably constructed of polypropylene netting approximately 1 inch by 1 inches, formed in a square right-angle grid orientation with the wires spaced at intervals of 3 to 12 inches. The size of the mesh is dependent on the application. The mesh size is selected to result in a given yield strength or may be sized to control the size of foam particle loss. The web 30 may be flexed or bent in some locations to allow the web 30 to follow the general contours of the underlying vessels 10 surface.

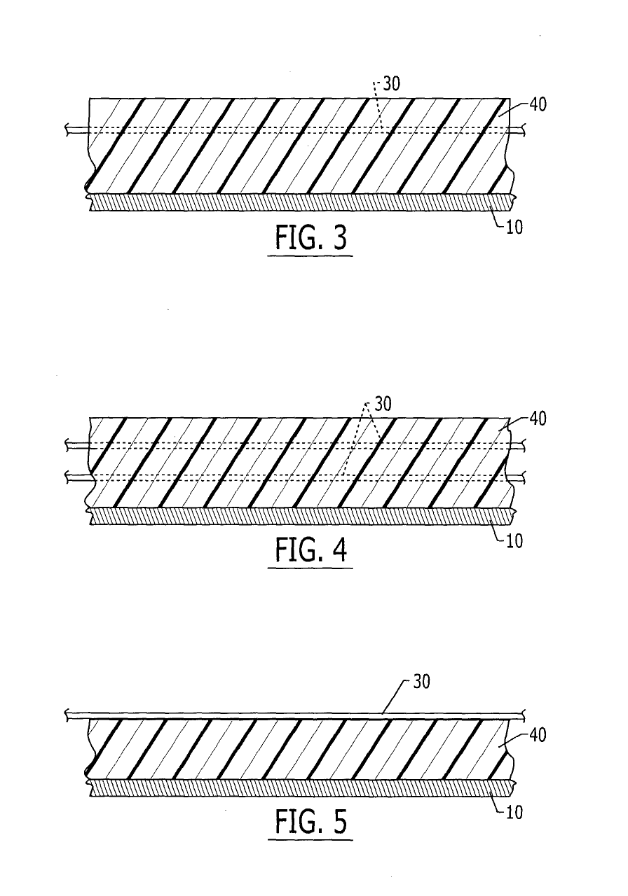

Referring to FIGS. 3 and 4, to fabricate the insulation without the use of spacer brackets, the web may be rested upon the outer surface of the vessel 10 prior to application of the foam 40. Spray-on foam is applied to the vessel 10 and web 30. As the spray-on foam expands during the spray application, the rising of the foam causes the web to be lifted from the surface of the vessel and suspended within the foam. The foam eventually cures with the web 30 embedded within the foam matrix.

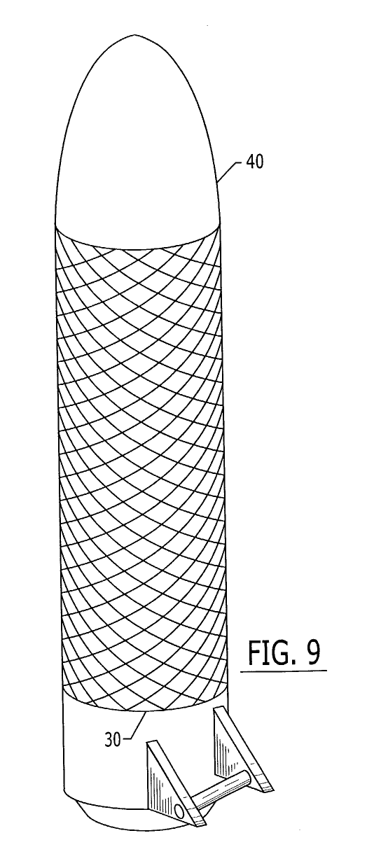

Referring to FIG. 5, the web 30 may alternatively be applied to the outer surface of the foam 40 after the foam has cured and hardened upon the vessel 10. The web 30 may be adhesively bound directly to the underlying foam layer. Referring to FIG. 9, when the web 30 is applied directly to the surface of an already cured foam 40 layer, the web 30 preferably provided about the circumference of the protected region of the vessel. In this manner, the tension of the web 30 acts to hold the foam against the surface of the vessel and prevent fragmented portions of the foam from separating from the vessel.

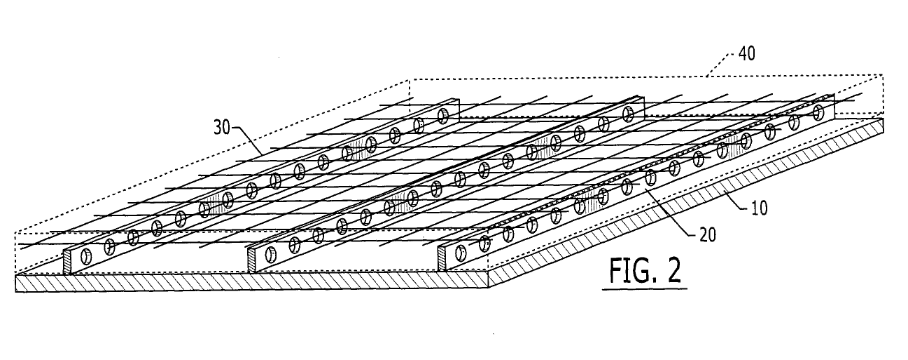

Referring now to FIG. 2, an embodiment of the reinforced insulation is shown that utilizes spacing brackets for further reinforcement. Spacing brackets 20 are attached to the surface of the vessel 10, and a web 30 is attached to the spacing brackets 20 such that the web 30 is physically spaced away from the surface of the vessel 10. Spray-on foam insulation 40 is applied to the surface of the vessel 10 over top of and through the spacer brackets 20 and web 30. The foam 40 adheres to the surface of the vessel 10 and envelopes the spacing brackets 20 and the web 30. Alternatively, the foam 40 envelopes the spacing brackets 20, and the surface of the foam opposite the vessel surface expands to contact but not envelope the outermost web 30.

The spacing brackets 20 are advantageously lightweight components that are attached to the outer surface of the vessel 10. Spray-on foam insulation is typically applied to a thickness of ⅛-inch to 3 inches, and the height of the brackets is generally equal to or less than the desired thickness of the resultant insulation. The brackets may be metal or other structural material capable of withstanding thermal cycling do to cryogenic loads, and capable of withstanding physical stresses acting upon the foam after the foam is installed around the brackets. In one embodiment, for example, the brackets are formed of aluminum. The brackets are preferably constructed of a material having a similar coefficient of thermal expansion as the material of the vessel 10 wall. The brackets 20 are preferably mounted to the vessel 10 with adhesives, but may be mounted to the vessel 10 by welding or by mechanical attachment.

The mesh web 30 is placed on top of the spacers such that the web contacts the outer portion of each respective bracket 20 and is suspended above the outer surface of the vessel 10 in the area between the spacers. The web 30 rests upon the brackets such that the web 30 is substantially parallel to the surface of the vessel 10 directly underlying each respective portion of the web 30. The web is preferably adhesively bound, welded, or mechanically attached to the brackets 20.

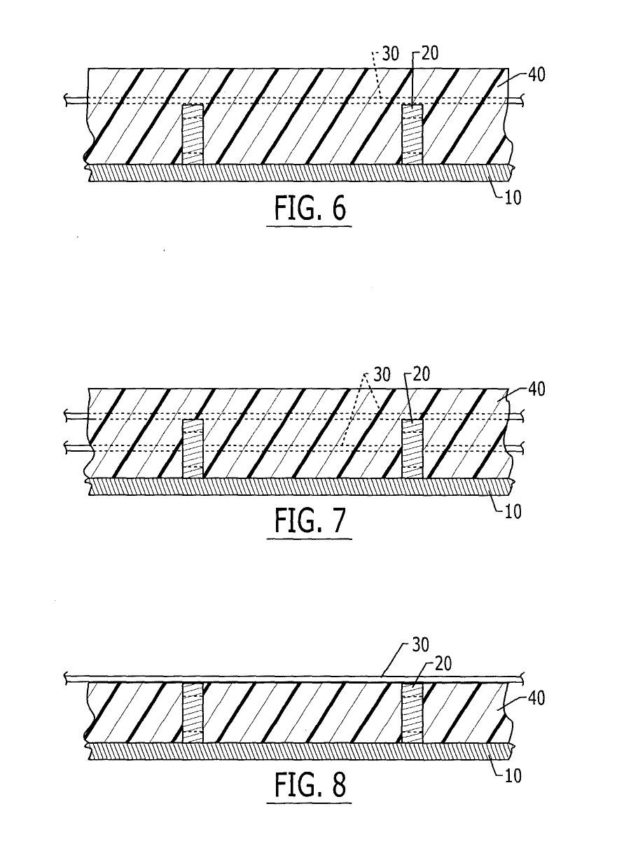

There is at least one layer of web 30 over each area of the vessel 10 where reinforcement is desired. The web 30 may be applied in multiple layers, each layer of which is separately attached to the brackets and is spaced apart from the other web layers. Referring to FIGS. 6 and 7, the foam 40 may be applied to a thickness that completely envelopes the brackets 20 and web 30, thereby preventing direct exposure of the web 30 to the atmosphere and providing the outer surface of the foam 40 with a smooth uniform surface. Also, if the web 30 is not previously attached to the brackets 20, the web will become entrained in the foam and fixed into place as the foam cures. The web 30 may be affixed to the brackets 20 before or after the brackets 20 are affixed to the vessel 10 wall.

The brackets 20 are preferably bound to the vessel wall 10 using either an epoxy or polyurethane adhesive. Similarly, the web 30 is preferably bound to the brackets 20 with an epoxy or polyurethane adhesive. Any exemplary epoxy is Hysol® EA 9330 Epoxy Paste Adhesive available from Locktite Aerospace, Bay Point, Calif. An exemplary polyurethane is Lord 212™ polyurethane adhesive available from Lord Corporation, Cary, N.C.

Referring to FIG. 8, the foam may be applied to a thickness such that the outermost web 30 component adjoins the outer surface of the foam 40, without being enveloped by the foam. One advantage of having the outermost web layer exposed is the ease of visual inspection of the outermost web.

Once applied, the foam 40 is held in place upon the surface of the vessel 10 by the adhesive bond of the polymeric foam 40 material with the outer surface of the vessel 10, and by the web components that are layered on top of the foam or interspersed throughout the foam matrix. If spacer brackets are used in the insulation, the brackets also assist in securing the foam to the vessel.

The reinforced insulation of the present invention may advantageously be employed on land, sea, air, or space vehicles that utilize cryogenic fuels as propellants and that experience strong vibrations, or large hydrodynamic or aerodynamic stresses during operation.

The reinforced foam insulation is typically formed directly upon the surface of a cryogenic vessel. However, according to yet another embodiment, a discrete section of the insulation may be produced by temporarily mounting the brackets, web, and foam upon a forming surface having release characteristics with respect to the spray-on foam. After the foam has cured, the section of insulation is removed from the forming surface. The pre-formed insulation may be mounted directly to a cryogenic vessel by mounting the brackets to the vessel surface and, optionally, applying an adhesive layer between the outer surface of the vessel and the cured foam.

The web of the invented insulation provide structural reinforcement to sprayed-on foam, thereby decreasing the likelihood that the adhesive bond between the foam and the vessel will fail. If the adhesive bond between the foam and vessel does fail, the web of the invented insulation provides a retaining function, thereby preventing portions of the foam from separating from the vessel. In the event that pressure develops under the insulation due to vaporization of cryopumped air, the pressure is safely released through the foam cracks without loss of foam material. The embedded webbing provides structural support and strength to hold fragments of cracked foam in place.

### EXAMPLE

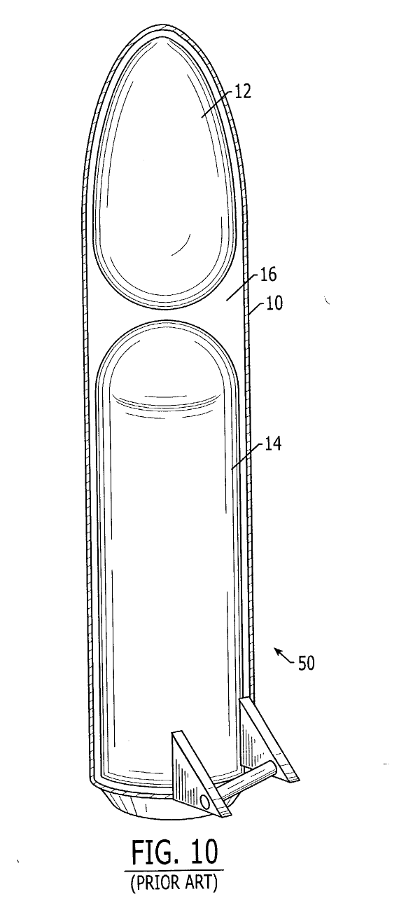

An example of particular usefulness is application of the invented insulation to the External Tank (ET) of the Space Shuttle Orbiter. The ET is a vessel 10 that contains multiple cryogenic storage tanks and is currently used during launch of the Orbiter. Referring to FIG. 10, an exemplary ET 50 comprises a vessel 10 that houses a liquid oxygen tank 12 in its forward section and a liquid hydrogen tank 14 in its aft section. The ET vessel 10 further houses an intertank section 16 that contains electronics, structural hardware, and venting systems. The structural components of the ET vessel 10 may be steel, aluminum, or aluminum alloy. The skin of the ET vessel 10 is typically constructed of aluminum or an aluminum alloy, and the outer surface of the ET vessel 10 is smoothly surfaced over most portions of the External Tank.

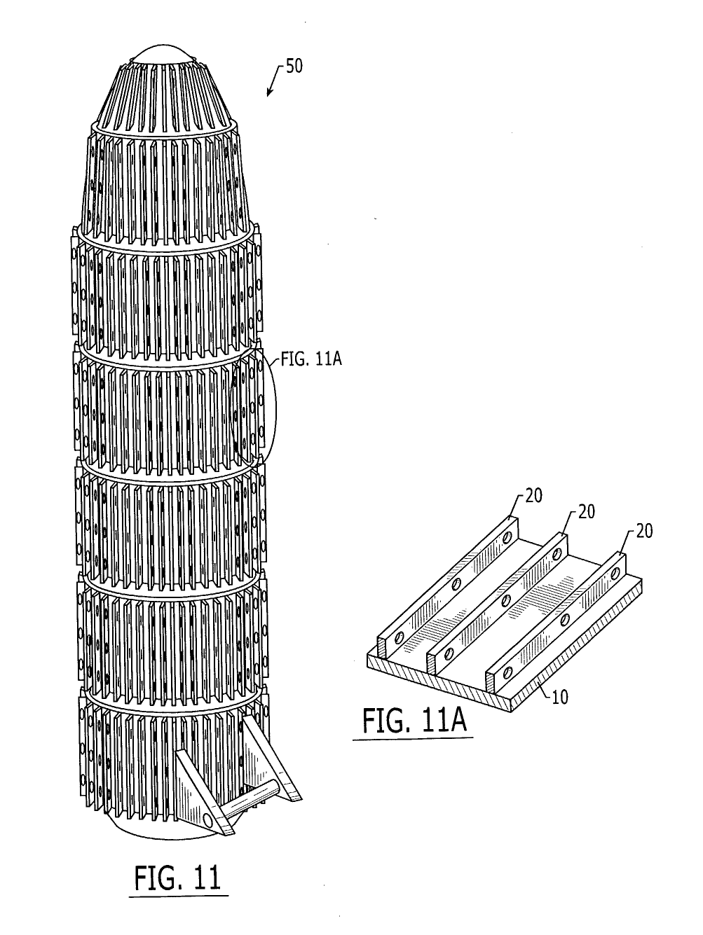

Referring to FIGS. 11 and 11a, an exemplary spacer bracket 20 has a length of aluminum approximately ½-inch in width, approximately 1-inch in height, and approximately 1 ft to 12 ft in length. Each aluminum bracket 20 has material removed from the cross-section of the bracket 20 in order to minimize weight and to minimize heat conduction through the body of the bracket 20. The bracket 20 is adhesively bound to the aluminum external tank 50 with Hysol® EA 9330 Epoxy Paste Adhesive available from Locktite Aerospace, Bay Point, Calif. The number of spacers and the distance between adjoining spacers vary with the tank diameter, the mass of foam to be applied to the tank surface of each region of the tank, and the predicted effect of external forces upon each particular region of the tank, such as physical forces experienced during liftoff of a cryogenic vessel aboard a launch vehicle.

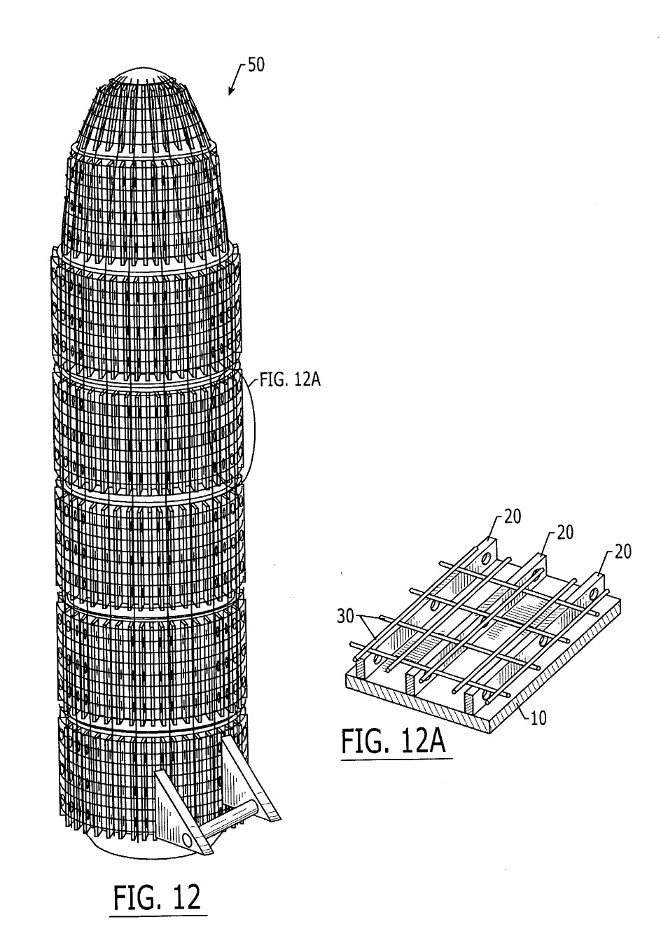

Referring to FIGS. 12 and 12a, a web 30 is applied on top of the spacer brackets 20. The web is a light-weight, high-strength, multiple-strand polypropylene netting, with stands evenly spaced in a repeating square pattern, each approximately 1 inch by 1 inch. Hysol® EA 9330 Epoxy Paste Adhesive is used to bond the web to the spacers at each point of contact. A single layer of web 30 is installed over substantially the entire surface of the External Tank.

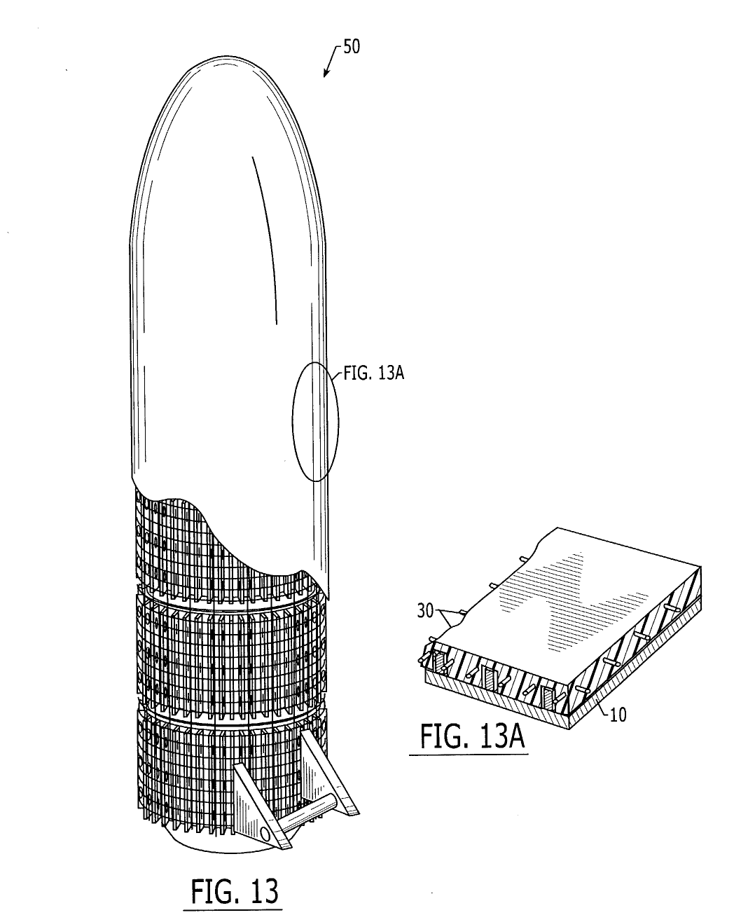

Referring to FIGS. 13 and 13a, a closed-cell polyurethane foam is sprayed on the External Tank 50 according to previously known methods of spraying foam. The foam 40 is applied to the tank, around the spacer brackets and webbing in a manner and to an extent that results in a foam having a density of about 1.8 lb/ft³, closed cell content of about 93%, and overall thickness of about 1¼ inches as measured from the surface of the ET. After rising and curing, the foam completely surrounds the brackets 20 and web 30 components of the insulation and provides and smooth, uniform outer surface to the ET.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A cryogenic fluid storage system comprising
a vessel that defines an inner volume and has an outer surface;
at least one web layer spaced away from the outer surface of the vessel; and
a polymeric foam layer adhesively bound to at least a portion of the outer surface of the vessel;
wherein at least a portion of the foam layer is contained between the at least one web layer and the outer surface of the vessel.

2. The cryogenic fluid storage system of claim 1, wherein the vessel is a metallic tank.

3. The cryogenic fluid storage system of claim 1, further comprising at least one spacing bracket attached to the outer surface of the vessel and attached to the at least one web layer.

4. The cryogenic fluid storage system of claim 3, wherein the foam layer forms a matrix around the at least one spacing bracket.

5. The cryogenic fluid storage system of claim 4, wherein the at least one spacing bracket is a metallic bracket that is adhesively attached to the outer surface of the vessel.

6. The cryogenic fluid storage system of claim 1, wherein the at least one web layer is constructed of materials selected from the group consisting of metal, carbon fibers, and polymeric fibers.

7. The cryogenic fluid storage system of claim 1, wherein the foam layer is a foam selected from the group consisting of closed cell polyurethane foam and open cell polyurethane foam.

8. The cryogenic fluid storage system of claim 1, wherein the foam layer contacts the at least one web layer at the outer surface of the foam layer.

9. The cryogenic fluid storage system of claim 8, wherein the foam layer forms a matrix around the at least one web layer.

10. The cryogenic fluid storage system of claim 8, wherein the foam layer has a thickness from ⅛-inch to 3-inches.

11. A method of reinforcing spray-on foam insulation, comprising the steps of
mounting spacing brackets to the outer surface of a vessel;
mounting at least one web layer to the spacing brackets such that the at least one web layer is spaced apart from the outer surface of the vessel; and
applying spray-on foam insulation to the outer surface of the vessel.

12. The method of claim 11, wherein the step of mounting spacing brackets to the outer surface of the vessel comprises adhesively bonding spacing brackets to the outer surface of the vessel.

13. The method of claim 11, wherein the step of mounting at least one web layer to the spacing brackets comprises mounting at least one web layer to the spacing brackets such that each region of the at least one web layer is substantially parallel to the outer surface of the vessel underlying that region of the web.

14. The method of claim 11, wherein the step of mounting at least one web layer to the spacing brackets comprises adhesively bonding at least one web layer to the spacing brackets.

15. The method of claim 11, wherein the step of applying spray-on foam insulation further comprises forming a resultant foam layer matrix around the spacing brackets.

16. The method of claim 15, wherein the step of applying spray-on foam insulation further comprises forming a resultant foam layer such that at least a portion of the spray-on foam contacts the web layer.

17. The method of claim 16, wherein the step of applying spray-on foam insulation further comprises forming a resultant foam layer matrix around the at least one web layer.

18. An insulating system resulting from the method of claim 11.

19. A reinforced cryogenic insulation comprising:
at least one spacing bracket adapted to mount to a cryogenic storage vessel;
at least one web layer mounted to said at least one spacing bracket; and
a layer of polymer foam at least partially surrounding said at least one spacing bracket and at least one web layer.

20. A method of reinforcing spray-on foam insulation, comprising the steps of
applying spray-on foam insulation to the outer surface of a vessel; and,
applying at least one web layer to the outer surface of the foam insulation.

21. The method of claim 20, wherein the vessel has a circumference and wherein the at least one web layer is applied about the circumference of the vessel.
